(19) United States
(12) Patent Application Publication
(10) Pub. No.: US 2025/0238527 A1
(43) Pub. Date: Jul. 24, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Jun KANAI, Inagi Tokyo (JP); Tatsuya UEHARA, Kawasaki Kanagawa (JP); Toshiyuki KITO, Kodaira Tokyo (JP)

(73) Assignee: KABUSHIKI KAISHA TOSHIBA, Tokyo (JP)

(21) Appl. No.: 19/029,752

(22) Filed: Jan. 17, 2025

(30) Foreign Application Priority Data
Jan. 22, 2024 (JP) 2024-007177

(51) Int. Cl. G06F 21/57

(52) U.S. Cl. CPC G06F 21/577; G06F 2221/033

(57) ABSTRACT

According to one embodiment, an information processing device includes a memory and one or more processors coupled to the memory. The one or more processors are configured to: determine a software component having a possibility that a vulnerability is present, among a plurality of software components defined in a first software bill of materials; and generate a second software bill of materials according to the determined software component.

### CROSS-REFERENCE TO RELATED APPLICATIONS

This application is based upon and claims the benefit of priority from Japanese Patent Application No. 2024-007177, filed on Jan. 22, 2024; the entire contents of which are incorporated herein by reference.

### FIELD

Embodiments described herein relate generally to an information processing device, an information processing method, and a computer program product.

### BACKGROUND

In recent years, for the purpose of license compliance and security assurance, risks such as vulnerabilities have been managed using software bills of materials (SBOMs).

However, in the related art, software bills of materials are managed in units of software, and are not managed at a granularity necessary for vulnerability management.

### BRIEF DESCRIPTION OF THE DRAWINGS

FIG. 1 is a schematic diagram of an information processing device;

FIG. 2 is a schematic diagram of a first software bill of materials;

FIG. 3 is a schematic diagram of a data configuration of vulnerability list information;

FIG. 4 is an explanatory diagram of a software component having a possibility that a vulnerability is present;

FIG. 5 is an explanatory diagram of a result of determination by an operation determination module;

FIG. 6 is an explanatory diagram of generation of second software bills of materials;

FIG. 7 is a flowchart of a procedure of information processing executed by the information processing device;

FIG. 8 is an explanatory diagram of a plurality of first software bills of materials acquired by an acquisition module;

FIG. 9 is a schematic diagram of a data configuration of vulnerability list information;

FIG. 10 is an explanatory diagram of a software component having a possibility that a vulnerability is present;

FIG. 11 is an explanatory diagram of a result of determination by an operation determination module;

FIG. 12 is an explanatory diagram of generation of a second software bill of materials;

FIG. 13 is a flowchart of a procedure of information processing executed by an information processing device; and

FIG. 14 is a hardware configuration diagram.

### DETAILED DESCRIPTION

In general, according to one embodiment, an information processing device includes a memory and one or more processors coupled to the memory. The one or more processors are configured to: determine a software component having a possibility that a vulnerability is present, among a plurality of software components defined in a first software bill of materials; and generate a second software bill of materials according to the determined software component.

Exemplary embodiments of an information processing device, an information processing method, and a computer program product will be explained below in detail with reference to the accompanying drawings. The present invention is not limited to the following embodiments.

Note that, in the following description of each embodiment, parts denoted by the same reference signs have substantially the same functions, and the description of the overlapping parts will be omitted as appropriate.

### First Embodiment

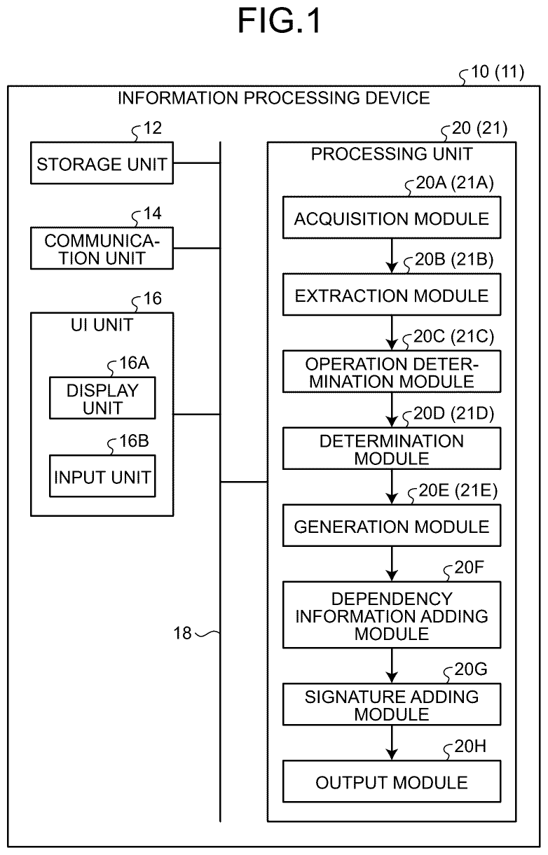

FIG. 1 is a schematic diagram of an example of an information processing device 10 according to the present embodiment.

The information processing device 10 includes a storage unit 12, a communication unit 14, a user interface (UI) unit 16, and a processing unit 20. The storage unit 12, the communication unit 14, the UI unit 16, and the processing unit 20 are communicably connected via a bus 18 or the like.

The storage unit 12 stores various types of information. The storage unit 12 may be a storage device provided outside the information processing device 10. For example, the storage unit 12 may be mounted on an external information processing device connected to the information processing device 10 via a network or the like.

The communication unit 14 is a communication interface that communicates with the external information processing device or the like via the network or the like.

The UI unit 16 has a display function of displaying various types of information and an input function of receiving an operation instruction by a user. In the present embodiment, the UI unit 16 includes a display unit 16A and an input unit 16B. The display unit 16A is a display that displays various types of information. The input unit 16B receives an operation input by the user. The input unit 16B is, for example, a pointing device such as a mouse, a keyboard, or the like. Note that the UI unit 16 may be a touch panel in which the display unit 16A and the input unit 16B are integrally configured.

The processing unit 20 executes information processing in the information processing device 10. The processing unit 20 includes an acquisition module 20A, an extraction module 20B, an operation determination module 20C, a determination module 20D, a generation module 20E, a dependency information adding module 20F, a signature adding module 20G, and an output module 20H.

The acquisition module 20A, the extraction module 20B, the operation determination module 20C, the determination module 20D, the generation module 20E, the dependency information adding module 20F, the signature adding module 20G, and the output module 20H are implemented by, for example, one or a plurality of processors. For example, each of the above-described units may be implemented by causing a processor such as a central processing unit (CPU) to execute a program, that is, by software. Each of the above-described units may be implemented by a processor such as a dedicated IC, that is, by hardware. Each of the above-described units may be implemented by using the software and the hardware in combination. In the case of using a plurality of processors, each of the processors may implement one of the units, or may implement two or more of the units. Furthermore, at least one of the above-described units may be provided in the external information processing device connected to the information processing device 10 via the network.

The acquisition module 20A acquires a first software bill of materials.

The first software bill of materials is a component list that defines software components included in a software product. The software product is, for example, an operating system (OS), an application program or application software (App), or the like. Examples of the OS include, but are not limited to, Linux (registered trademark), Unix (registered trademark), Windows (registered trademark), Android (registered trademark), iOS (registered trademark), and the like. Each of these software products operates while using or including one or more software components. Each of the software components may also be referred to as a driver, a service, a library, or the like. For example, Linux operates while using or including a kernel function of an OS main body and software components such as a large number of device drivers and services.

Examples of the first software bill of materials include a software bill of materials (SBOM).

In the present embodiment, a mode in which the acquisition module 20A acquires a defined first software bill of materials of a plurality of software components as the first software bill of materials to be processed in the information processing device 10 will be described as an example. The defined first software bill of materials of the plurality of software components indicates a first software bill of materials of a software product that operates while using or including the plurality of software components.

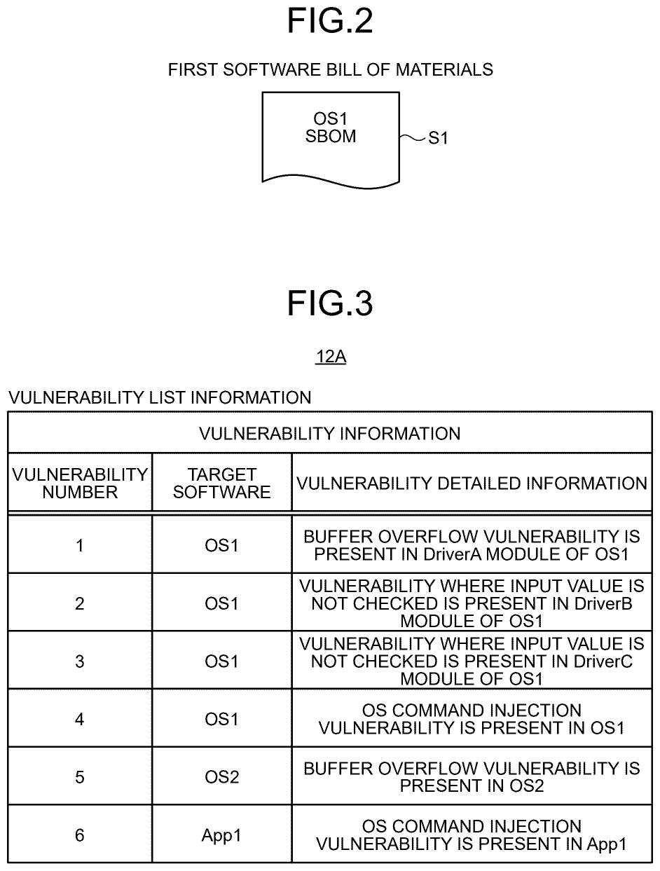

FIG. 2 is a schematic diagram of an example of a first software bill of materials S1. FIG. 2 illustrates a form in which the first software bill of materials S1 is an SBOM of a software product “OS1” as an example.

Returning to FIG. 1, the description will be continued.

The format of the first software bill of materials S1 acquired by the acquisition module 20A is not limited. For example, the format of the first software bill of materials S1 may be a known format such as Software Package Data Exchange (SPDX) or CycloneDX, or may be a software bill of materials managed by using a spreadsheet or the like.

The acquisition module 20A may acquire the first software bill of materials S1 stored in the storage unit 12, or may acquire the first software bill of materials S1 from the external information processing device or the like via the communication unit 14.

The extraction module 20B extracts a software component that is included in the first software bill of materials S1 and has a possibility that a vulnerability is present, based on vulnerability list information regarding the vulnerability.

FIG. 3 is a schematic diagram of an example of a data configuration of vulnerability list information 12A. The vulnerability list information 12A is a database in which information regarding vulnerability is centrally managed.

For example, the vulnerability list information 12A is information in which a vulnerability and a plurality of pieces of vulnerability information are defined for each software component having a possibility that a vulnerability is present. The vulnerability information includes, for example, a vulnerability number, target software, and vulnerability detailed information. Note that the vulnerability information may further include other information regarding the vulnerability. The vulnerability number is identification information of the vulnerability information. The target software is identification information of a software product including one or more software components. As the target software, the name of the software product, an identifier that uniquely identifies the software, such as common platform enumeration (CPE), SWID, or PackageURL, and the like are used. An identifier that can also identify the version of the software product may be used as the target software.

The vulnerability detailed information is detailed information regarding a vulnerability included in a software component included in the software product identified by the corresponding target software. FIG. 2 illustrates an example in which the vulnerability detailed information is described in a pattern of “vulnerability is present” of “vulnerability type” in “software component name” of “target software”.

The extraction module 20B reads the vulnerability list information 12A from the external information processing device via the storage unit 12 or the communication unit 14. The extraction module 20B may use a public database such as the National Vulnerability Database (NVD) or Japan Vulnerability Notes (JVN) as the vulnerability list information 12A, or may use Vulnerability Exploitability exchange (VEX) information or the like included in the SBOM that is the first software bill of materials S1 as the vulnerability list information 12A.

Based on the acquired vulnerability list information 12A, the extraction module 20B extracts a software component having a possibility that a vulnerability is present among a plurality of software components defined in the first software bill of materials S1 acquired by the acquisition module 20A. A software component having a possibility that a vulnerability is present is a software component in which a vulnerability is present or in which there is a possibility that a vulnerability is present.

The extraction module 20B extracts a software component defined in the vulnerability list information 12A among the software components included in the first software bill of materials S1 acquired by the acquisition module 20A as a software component having a possibility that a vulnerability is present.

Specifically, for example, it is assumed that the first software bill of materials S1 acquired by the acquisition module 20A is the SBOM of the software product “OS1”. In this case, the extraction module 20B reads vulnerability information of defined vulnerability numbers “1” to “4” of the software product “OS1” from the vulnerability list information 12A. Furthermore, the extraction module 20B reads a software component name defined in the vulnerability detailed information included in each piece of the read vulnerability information. By this reading processing, the extraction module 20B extracts a software component having the read software component name as a software component having a possibility that a vulnerability is present among the plurality of software components defined in the first software bill of materials S1 acquired by the acquisition module 20A.

For example, as described above, the vulnerability detailed information of the vulnerability list information 12A illustrated in FIG. 3 is described in a pattern of “vulnerability is present” of “vulnerability type” in “software component name” of “target software”. Therefore, in this case, the extraction module 20B analyzes the vulnerability detailed information included in the vulnerability information of the defined vulnerability numbers “1” to “4” of the software product “OS1”, thereby extracting software components “DriverA”, “DriverB”, and “DriverC” defined in the vulnerability detailed information as software components having a possibility that a vulnerability is present among the software components defined in the first software bill of materials S1 of the software product “OS1”. In addition, in the case of the vulnerability list information 12A illustrated in FIG. 3, the extraction module 20B may further extract the software product “OS1” itself as a software component having a possibility that a vulnerability is present by analyzing the vulnerability information of the vulnerability number “4”.

The extraction module 20B may analyze the vulnerability information by using simple pattern matching, natural language processing, or the like, or may analyze the vulnerability information by natural language processing.

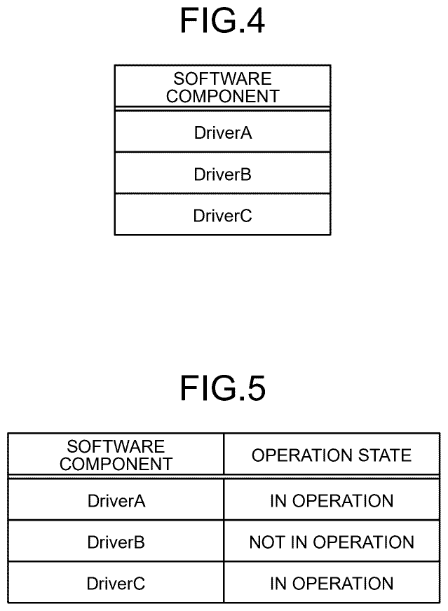

FIG. 4 is an explanatory diagram of an example of the software component that has been extracted by the extraction module 20B and has a possibility that a vulnerability is present. For example, the extraction module 20B analyzes the vulnerability detailed information included in the vulnerability information of the defined vulnerability numbers “1” to “4” of the software product “OS1” based on the vulnerability list information 12A, thereby extracting the software components “DriverA”, “DriverB”, and “DriverC” defined in the vulnerability detailed information as software components having a possibility that a vulnerability is present among the software components defined in the first software bill of materials S1 of the software product “OS1”.

Returning to FIG. 1, the description will be continued.

The operation determination module 20C determines whether or not each software component that has been extracted by the extraction module 20B and has a possibility that a vulnerability is present among the software components defined in the first software bill of materials S1 is likely to operate in an introduction target device into which the software component is to be introduced. Whether or not the software component is likely to operate means whether or not the software component is in operation in the introduction target device, or whether or not there is a possibility that the software component operates in the introduction target device.

For example, the operation determination module 20C determines whether or not the software component is likely to operate by determining whether or not the software component is being used, based on an execution history of the software component (for example, a program) that is actually operating. In addition, the operation determination module 20C may determine whether or not the software component is likely to operate by determining whether or not the software component is included by analyzing the software on the assumption that compiling is performed in a state in which the software component (for example, a module) is not included according to an option at the time of the compiling. In addition, the operation determination module 20C may determine whether or not the software component is likely to operate by using configuration setting at the time of the compiling or the like. In addition, the operation determination module 20C may determine whether or not the user uses the software component in advance, store information regarding a result of the determination, and determine whether or not the software component is likely to operate by using the stored information.

FIG. 5 is an explanatory diagram of an example of the result of the determination by the operation determination module 20C. FIG. 5 illustrates an example of the result of determining whether or not the software components “DriverA”, “DriverB”, and “DriverC” extracted by the extraction module 20B as the software components having a possibility that a vulnerability is present are likely to operate. In FIG. 5, “in operation” indicates a result of determining that the software components are likely to operate, and “not in operation” indicates a result of determining that the software component is not likely to operate.

Returning to FIG. 1, the description will be continued.

The determination module 20D determines a software component having a possibility that a vulnerability is present among the software components defined in the first software bill of materials S1.

For example, the determination module 20D determines a software component having a possibility that a vulnerability is present, based on the vulnerability list information 12A.

In addition, the determination module 20D may specify software components used in or included in the software product of the first software bill of materials S1 by analyzing a database that defines in advance the relationship between the software components and the software product. In addition, the determination module 20D may analyze the software product of the first software bill of materials S1 by static analysis or the like to specify the software components used in or included in the software product. Then, the determination module 20D may determine a software component having a possibility that a vulnerability is present using the vulnerability list information 12A and the like among the specified software components.

As described above, in the present embodiment, the acquisition module 20A acquires the defined first software bill of materials S1 of the plurality of software components. The extraction module 20B extracts a plurality of software components that are included in the first software bill of materials S1 and have a possibility that a vulnerability is present, based on the vulnerability list information 12A. Therefore, in the present embodiment, the determination module 20D determines the plurality of software components extracted by the extraction module 20B among the software components defined in the first software bill of materials S1, thereby determining the plurality of software components having a possibility that a vulnerability is present.

Furthermore, in the present embodiment, the determination module 20D preferably determines a software component determined to be likely to operate by the operation determination module 20C among the plurality of software components that have been extracted by the extraction module 20B and having a possibility that a vulnerability is present.

In the example illustrated in FIG. 5, the determination module 20D determines the software components “DriverA” and “DriverC” determined to be likely to operate among the software components “DriverA”, “DriverB”, and “DriverC” that have been extracted by the extraction module 20B and having a possibility that a vulnerability is present.

That is, the determination module 20D preferably determines a software component which is likely to operate and has a possibility that a vulnerability is present among the plurality of software components defined in the first software bill of materials S1. Here, even when software components are the same, not all the software components may be necessarily used depending on the setting at the time of compiling or the operating environment. Therefore, the determination module 20D determines a software component in which a vulnerability is present and which is likely to operate. By performing such determination processing by the determination module 20D, a software component having a possibility that a vulnerability that cannot be expressed in practice of vulnerability handling is present can be excluded from a target for generation of a second software bill of materials to be described later. Furthermore, in this case, the determination module 20D can save labor for handling.

Returning to FIG. 1, the description will be continued.

The generation module 20E generates second software bills of materials according to the software components determined by the determination module 20D.

In the present embodiment, the generation module 20E generates the second software bills of materials for each of the plurality of software components determined by the determination module 20D.

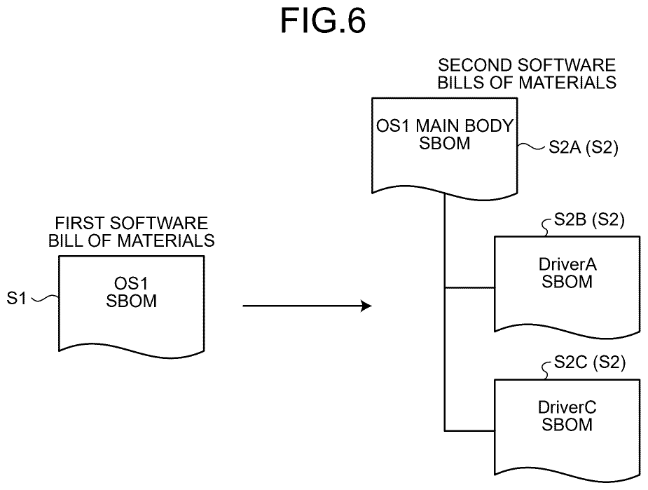

FIG. 6 is an explanatory diagram of an example of the generation of the second software bills of materials S2 by the generation module 20E. For example, a scene is assumed in which the acquisition module 20A acquires the first software bill of materials S1 which is the SBOM of the software product “OS1” illustrated in FIG. 6, and the determination module 20D determines the software components “DriverA” and “DriverC” which are likely to operate and have a possibility that a vulnerability is present.

In this case, the generation module 20E generates a second software bill of materials S2B for the software component “DriverA” and a second software bill of materials S2C for the software component “DriverC”. Each of the second software bill of materials S2B and the second software bill of materials S2C is an example of the second software bill of materials S2.

In addition, the generation module 20E may further generate the acquired first software bill of materials S1 as a second software bill of materials S2A as it is. The second software bill of materials S2A is an example of the second software bill of materials S2. When the extraction module 20B determines that there is a possibility that a vulnerability is present in the software product “OS1” defined in the first software bill of materials S1, the generation module 20E may further generate the acquired first software bill of materials S1 as the second software bill of materials S2A as it is.

FIG. 6 illustrates a case where the generation module 20E generates the second software bills of materials S2 for each of the software product “OS1” of the first software bill of materials and the software components “DriverA” and “DriverC” determined by the determination module 20D.

The generation module 20E generates the second software bills of materials S2 for each of the determined software components by copying an information part regarding the corresponding software components in the SBOM which is the first software bill of materials S1. When software names, identifiers, and the like are included in the second software bills of materials S2, the generation module 20E replaces the names and the identifiers of the software components with the names and the identifiers for the second software bills of materials S2. In addition, when Vulnerability-Exploitability exchange (VEX) information is included in the SBOM which is the first software bill of materials S1, the VEX information other than the corresponding software components may be deleted.

Returning to FIG. 1, the description will be continued.

The dependency information adding module 20F adds, to the second software bill of materials S2, dependency information indicating a dependency with respect to a software component defined in another second software bill of materials S2. The dependency information is, for example, information indicating whether a certain software component is high-level software or low-level software for another software component. The high-level software is software including one or more pieces of the low-level software. The low-level software is software included as a software part in the high-level software.

For example, it is assumed that the software product “OS1” is high-level software including the software components “DriverA”, “DriverB”, and “DriverC”. In this case, the dependency information adding module 20F adds dependency information by including the identifier of the software component or the software product that is the higher-level software for the lower-level software components in the second software bills of materials S2 of the software components which are lower-level software. In addition, the dependency information adding module 20F adds dependency information by including the identifiers of the software components that are the lower-level software for the software product or the higher-level software component in the second software bill of materials S2 of the software product or the higher-level software component which is higher-level software.

By adding the dependency information, for example, as illustrated in FIG. 6, the dependency information adding module 20F can add information indicating a hierarchical structure represented by the dependency information to the plurality of generated second software bills of materials S2.

Returning to FIG. 1, the description will be continued.

The signature adding module 20G adds a signature to the second software bills of materials S2. As the signature, a known signature for tampering detection may be used. For example, a signature using a public key, a signature using a private key, or the like may be used as the signature.

The signature adding module 20G preferably adds one signature to at least some or the whole of the plurality of second software bills of materials S2 having a dependency.

Specifically, in the example illustrated in FIG. 6, for example, the extraction module 20B may add a signature to each of the second software bill of materials S2A, the second software bill of materials S2B, and the second software bill of materials S2C. In addition, the signature adding module 20G may add a signature to each of the second software bill of materials S2A, the second software bill of materials S2B, and the second software bill of materials S2C. In addition, the signature adding module 20G may add one signature to the whole of the second software bills of materials S2A, S2B, and S2C. In addition, the signature adding module 20G may add one signature to at least some or the whole of the plurality of second software bills of materials S2, and may also add a signature to the dependency information.

Since the signature adding module 20G adds one signature to at least some or the whole of the plurality of second software bills of materials S2 having the dependency, it is possible to verify both the signature added by the signature adding module 20G and the original signature even in a case where the signature has already been added to the original data.

For example, a signature may already be added to the second software bill of materials S2A which is the first software bill of materials S1. In this case, the signature adding module 20G adds one signature to the whole of the second software bill of materials S2A, the second software bill of materials S2B, and the second software bill of materials S2C to which the dependency relation information has been added. Since the signature adding module 20G adds a signature in such a unit, it is possible to verify both the signature originally added to the first software bill of materials S1 which is the second software bill of materials S2A and the signature newly added to the whole by the signature adding module 20G. In addition, the signature originally added to the first software bills of materials S1 can be left as it is and used for verification.

Returning to FIG. 1, the description will be continued.

The output module 20H outputs the second software bills of materials S2.

The output module 20H may separately output each of the plurality of second software bills of materials S2 generated by the generation module 20E. In addition, the output module 20H may output the plurality of second software bills of materials S2 generated by the generation module 20E as one file together with the added dependency information.

A destination of the output by the output module 20H is not limited. For example, the output module 20H outputs the plurality of second software bills of materials S2 by storing the second software bills of materials S2 in the storage unit 12. In addition, the output module 20H outputs the plurality of second software bills of materials S2 by displaying the second software bills of materials S2 on the input unit 16B. In addition, the output module 20H outputs the plurality of second software bills of materials S2 by transmitting the second software bills of materials S2 to the external information processing device or the like via the communication unit 14.

Next, an example of a procedure of information processing executed by the information processing device 10 according to the present embodiment will be described.

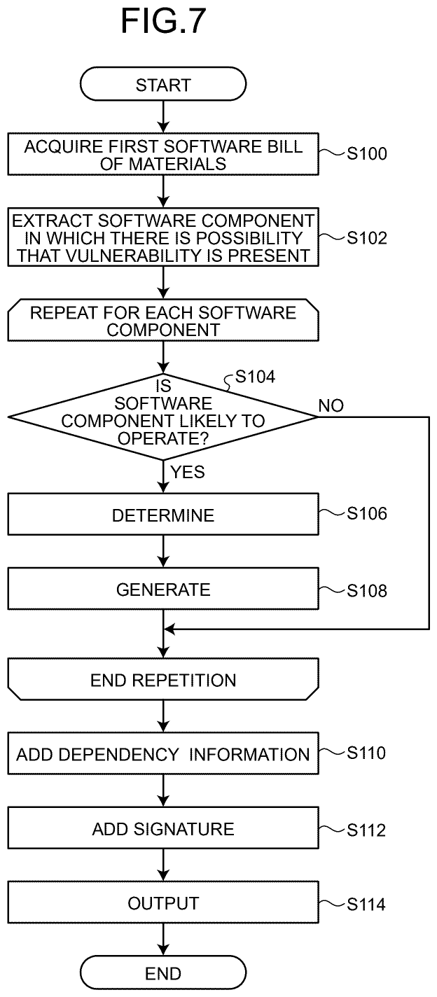

FIG. 7 is a flowchart illustrating the example of the procedure of the information processing executed by the information processing device 10 according to the present embodiment.

The acquisition module 20A acquires the first software bill of materials S1 to be processed (Step S100). Based on the vulnerability list information 12A, the extraction module 20B extracts a software component that is included in the first software bill of materials S1 acquired in Step S100 and has a possibility that a vulnerability is present (Step S102).

Then, the processing unit 20 repeats processing of Steps S104 to S108 for each software component extracted in Step S102.

Specifically, the operation determination module 20C determines whether or not the software component that has been extracted in Step S102 and has a possibility that a vulnerability is present is likely to operate in an introduction target device into which the software component is to be introduced (Step S104). When a negative determination is made in Step S104 (Step S104: No), the software component is determined and excluded from a target for generation of a second software bill of materials S2. When an affirmative determination is made in Step S104 (Step S104: Yes), the processing proceeds to Step S106.

In Step S106, the determination module 20D determines the software component for which the affirmative determination was made in Step S104, as a target for the generation of the second software bill of materials S2 (Step S106).

The generation module 20E generates the second software bill of materials S2 of the software component determined in Step S106 (Step S108).

The processing unit 20 executes the processing of Steps S104 to S108 for each software component extracted in Step S102, so that a second software bill of materials S2 is generated for each software component having a possibility that a vulnerability is present among the software components included in the first software bill of materials S1 and which has been determined to be likely to operate in the introduction target device.

Next, the dependency information adding module 20F adds, to the second software bill of materials S2 generated in Step S108, dependency information indicating a dependency with respect to a software component defined in another second software bill of materials S2 (Step S110).

The signature adding module 20G adds a signature to the second software bills of materials S2 to which the dependency information has been added (Step S112).

The output module 20H outputs the second software bills of materials S2 generated in Step S108 and to which the dependency relation information and the signature have been added in Steps S110 and S112 (Step S114). Then, this routine is ended.

As described above, the information processing device 10 according to the present embodiment includes the determination module 20D and the generation module 20E. The determination module 20D determines a software component having a possibility that a vulnerability is present among the software components defined in the first software bill of materials S1. The generation module 20E generates a second software bills of materials S2 according to the determined software component.

Here, in the related art, software bills of materials are managed in units of software, and are not managed at a granularity necessary for vulnerability management. Specifically, the conventional SBOMs are often made on the extension of license compliance management, and the management granularity of the SBOMs is not necessarily optimal in the vulnerability management use case. For example, it is expected that the entire Linux kernel is managed by the GPLvp2 license, and the SBOMs are also managed by the entire Linux kernel. However, vulnerability often occurs not only in the kernel body but also in units of driver services included in the kernel. For this reason, it is desirable to manage the software bills of materials at a granularity according to such vulnerability. However, such management is not performed for the conventional SBOMs. That is, in the related art, the SBOMs are often managed on a software product basis, and it is not necessarily a desirable granularity as a vulnerability management unit. In other words, in the related art, the software bills of materials are managed in units of software, and are not managed at a granularity necessary for vulnerability management.

On the other hand, the information processing device 10 according to the present embodiment determines a software component having a possibility that a vulnerability is present among the software components defined in the first software bill of materials S1, and generates a second software bill of materials S2 according to the determined software component.

Therefore, in the information processing device 10 according to the present embodiment, it is possible to generate a second software bill of materials S2 for each software component having a possibility that a vulnerability is present.

Therefore, the information processing device 10 according to the present embodiment can manage software bills of materials at a granularity necessary for vulnerability management.

In addition, the information processing device 10 according to the present embodiment can provide a software bill of materials (second software bill of materials S2) at a granularity necessary for vulnerability management, and thus, for example, in a case where SBOMs are provided to a user and used as Vulnerability Exploitability exchange (VEX), the SBOMs can be separately provided.

In addition, in the information processing device 10 according to the present embodiment, a second software bill of materials S2 is generated for each software component having a possibility that a vulnerability is present among the plurality of software components defined in the first software bill of materials S1. That is, the information processing device 10 according to the present embodiment can generate a plurality of second software bills of materials S2 obtained by dividing the first software bill of materials S1 according to the granularity of vulnerability. Therefore, in the information processing device 10 according to the present embodiment, similarly to the above-described effect, it is possible to provide the second software bills of materials S2 in a manageable manner at a granularity necessary for vulnerability management. Furthermore, in the information processing device 10 according to the present embodiment, it is possible to perform appropriate vulnerability handling.

### Second Embodiment

In the above-described embodiment, the mode of generating the plurality of second software bills of materials S2 obtained by dividing the first software bill of materials S1 according to the granularity of vulnerability has been described as an example. In the present embodiment, a mode of acquiring a plurality of first software bills of materials S1 and generating a second software bill of materials S2 in which at least some of the acquired plurality of first software bills of materials S1 are combined according to vulnerability will be described as an example.

FIG. 1 is a schematic diagram of an example of an information processing device 11 according to the present embodiment.

The information processing device 11 is similar to the information processing device 10 according to the above-described embodiment except that a processing unit 21 is included in the information processing device 11 instead of the processing unit 20.

The processing unit 21 includes an acquisition module 21A, an extraction module 21B, an operation determination module 21C, a determination module 21D, a generation module 21E, a dependency information adding module 20F, a signature adding module 20G, and an output module 20H. The dependency information adding module 20F, the signature adding module 20G, and the output module 20H are similar to those included in the processing unit 20 according to the above-described embodiment.

The acquisition module 21A acquires the plurality of first software bills of materials S1.

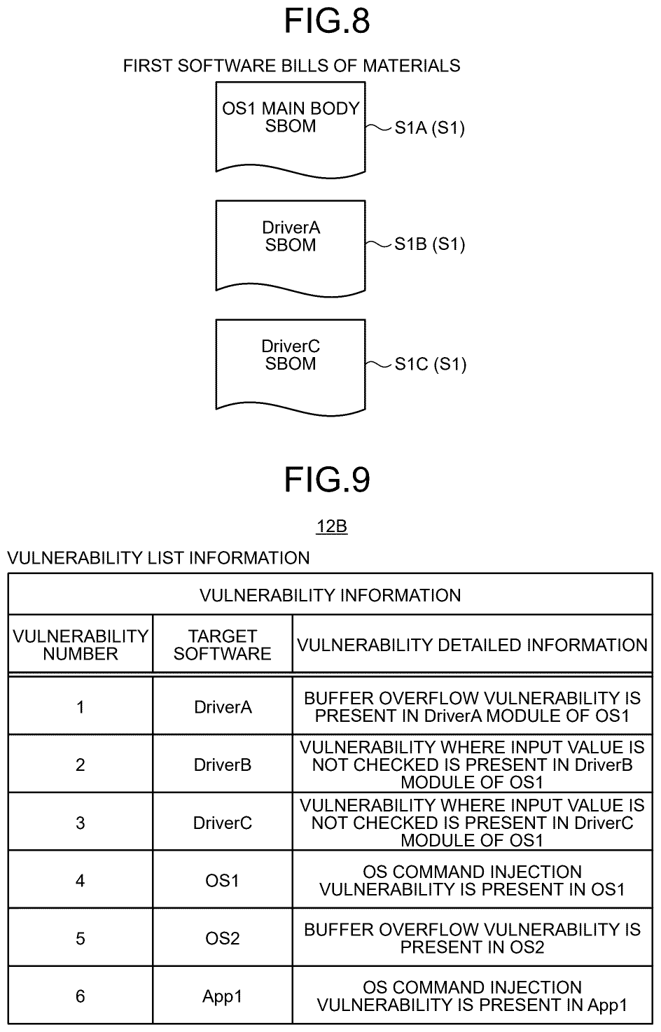

FIG. 8 is an explanatory diagram of an example of the plurality of first software bills of materials S1 acquired by the acquisition module 21A. In the present embodiment, for example, a case where the acquisition module 21A acquires the SBOMs of the software components OS1, DriverA, and DriverC, which are integrated as an actual software product, as the first software bills of materials S1 (the first software bills of materials S1A to SIC) will be described.

Returning to FIG. 1, the description will be continued. Similarly to the extraction module 20B, the extraction module 21B extracts a software component, which is included in the first software bills of materials S1 and has a possibility that a vulnerability is present, based on vulnerability list information regarding the vulnerability. In the present embodiment, the extraction module 21B extracts a software component having a possibility that a vulnerability is present among the software components defined in each of the plurality of first software bills of materials S1 (the first software bill of materials S1A to the first software bill of materials S1C) based on the vulnerability list information regarding the vulnerability.

FIG. 9 is a schematic diagram of an example of a data configuration of vulnerability list information 12B. Similar to the vulnerability list information 12A, the vulnerability list information 12B is a database in which information regarding vulnerability is centrally managed.

For example, the vulnerability list information 12B is information in which a vulnerability and a plurality of pieces of vulnerability information are defined for each software component having a possibility that a vulnerability is present. As in the vulnerability list information 12A, the vulnerability information includes a vulnerability number, target software, and vulnerability detailed information. In the present embodiment, the target software is identification information of each of the software product and the software components. As the target software, the name of the software product, the names of the software components, and the like are used. In addition, in the present embodiment, an example in which the vulnerability detailed information is described in a pattern of “vulnerability is present” of “vulnerability type” in “software component name” which is a lower-level software component name for “higher-level software component name” will be described as an example.

The extraction module 21B reads the vulnerability list information 12B from the external information processing device via the storage unit 12 or the communication unit 14. The extraction module 21B may use a public database such as the NVD or the JVN as the vulnerability list information 12B, or may use VEX information or the like included in the SBOM that is the first software bill of materials S1 as the vulnerability list information 12B.

The extraction module 21B extracts the software product or a software component defined in the vulnerability list information 12B among the software product or the software components defined in each of the plurality of first software bills of materials S1 acquired by the acquisition module 21A as a software component having a possibility that a vulnerability is present.

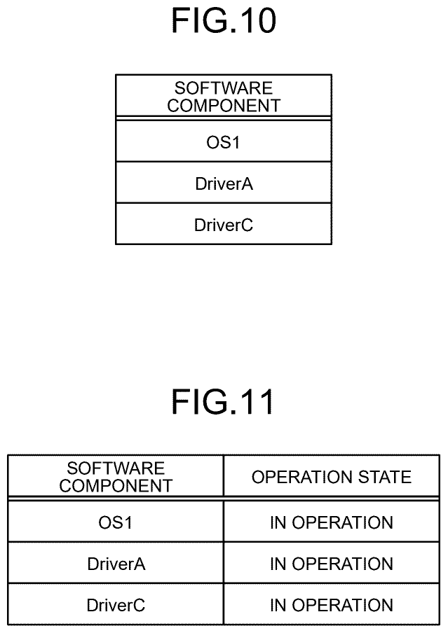

FIG. 10 is an explanatory diagram of an example of the software component that has been extracted by the extraction module 21B and has a possibility that a vulnerability is present.

It is assumed that the acquisition module 21A acquires the SBOMs of the software components OS1, DriverA, and DriverC illustrated in FIG. 8 as the first software bills of materials S1 (the first software bills of materials S1A to S1C). In this case, the extraction module 21B extracts the software components OS1, DriverA, and DriverC as software components having a possibility that a vulnerability is present, based on the vulnerability list information 12B (see FIG. 10).

In addition, the extraction module 21B specifies a dependency of each of the plurality of first software bills of materials S1 acquired by the acquisition module 21A, based on the acquired vulnerability list information 12B.

For example, it is assumed that the acquisition module 21A acquires the SBOMs of the software components OS1, DriverA, and DriverC illustrated in FIG. 8 as the first software bills of materials S1 (the first software bills of materials S1A to S1C). In this case, the extraction module 21B analyzes the vulnerability list information 12B illustrated in FIG. 9 to specify a dependency indicating that the software components DriverA, DriverB, and DriverC are software components included in OS1 or used in OS1. The extraction module 21B specifies the dependency by analyzing the vulnerability list information 12B by pattern matching, natural language processing, or the like.

Returning to FIG. 1, the description will be continued.

The operation determination module 21C determines whether or not each software component that has been extracted by the extraction module 21B and has a possibility that a vulnerability is present among the software components defined in the first software bills of materials S1 is likely to operate in an introduction target device into which the software component is to be introduced. The operation determination module 21C may determine whether or not the software component is likely to operate in a similar manner to the operation determination module 20C.

FIG. 11 is an explanatory diagram of an example of a result of the determination by the operation determination module 21C. FIG. 11 illustrates an example of a result of determining whether or not the software components “OS1”, “DriverA”, and “DriverC” extracted by the extraction module 21B as software components having a possibility that a vulnerability is present are likely to operate. In FIG. 11, “in operation” indicates a result of determining that the software components are likely to operate, and “not in operation” indicates a result of determining that a software component is not likely to operate.

Returning to FIG. 1, the description will be continued.

The determination module 21D determines a software component having a possibility that a vulnerability is present among the software components defined in each of the first software bills of materials S1.

In the present embodiment, the determination module 21D determines a plurality of software components having a possibility that a vulnerability is present among the software components defined in each of the plurality of first software bills of materials S1.

As described above, in the present embodiment, the acquisition module 21A acquires the plurality of first software bills of materials S1. Then, based on the vulnerability list information 12B, the extraction module 21B extracts a plurality of software components that are included in each of the plurality of first software bills of materials S1 and have a possibility that a vulnerability is present. Therefore, in the present embodiment, the determination module 21D determines the plurality of software components extracted by the extraction module 21B among the software components defined in each of the first software bills of materials S1, thereby determining the plurality of software components having a possibility that a vulnerability is present.

Furthermore, in the present embodiment, the determination module 21D determines a software component determined to be likely to operate by the operation determination module 21C among the plurality of software components that have been extracted by the extraction module 21B and have a possibility that a vulnerability is present.

In the example illustrated in FIG. 11, the determination module 21D determines the software components “OS1”, “DriverA”, and “DriverC” determined to be likely to operate among the software components “OS1”, “DriverA”, and “DriverC” that have been extracted by the extraction module 21B and have a possibility that a vulnerability is present.

In addition, the determination module 21D specifies a dependency between the plurality of determined software components.

The determination module 21D specifies the dependency by analyzing the vulnerability list information 12B by pattern matching, natural language processing, or the like. In addition, the determination module 21D acquires the dependency specified by the extraction module 21B to specify the dependency between the plurality of determined software components.

The generation module 21E generates a second software bill of materials S2 according to the software components determined by the determination module 21D.

In the present embodiment, the generation module 21E generates a second software bill of materials S2 for each combined software component obtained by combining at least some of the plurality of software components determined by the determination module 21D.

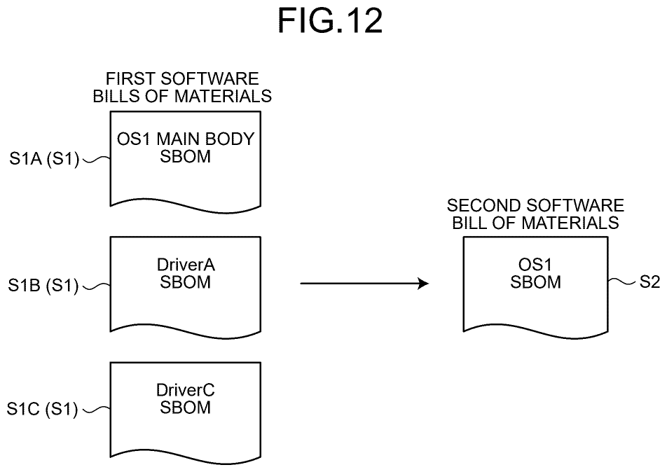

FIG. 12 is an explanatory diagram of an example of the generation of the second software bill of materials S2 in the present embodiment.

For example, a scene is assumed in which the acquisition module 21A acquires the first software bills of materials S1 (the first software bills of materials S1A to S1C) of the software product “OS1”, the software component “DriverA”, and the software component “DriverC”, and the determination module 21D determines the software components “OS1”, “DriverA”, and “DriverC” that are software components which have been determined to be likely to operate and have a possibility that a vulnerability is present.

In this case, the generation module 21E generates one second software bill of materials S2 for combined software obtained by combining the software components “OS1”, “DriverA”, and “DriverC”. For example, in the example illustrated in FIG. 12, the generation module 21E generates one second software bill of materials S2 for combined software obtained by combining the first software bill of materials S1A, the first software bill of materials S1B, and the first software bill of materials S1C.

In addition, the generation module 21E may generate one second software bill of materials S2 for combined software obtained by combining a plurality of software components having the specified dependency among the plurality of determined software components. For example, in the example illustrated in FIG. 12, the generation module 21E generates one second software bill of materials S2 for the combined software obtained by combining the first software bill of materials S1A, the first software bill of materials S1B, and the first software bill of materials S1C that have the dependency.

In addition, the generation module 21E only needs to generate a second software bill of materials S2 for each combined software component obtained by combining at least some of the plurality of software components determined by the determination module 21D, and may generate a second software bill of materials S2 for a combined software component obtained by combining some of the software components. For example, in the example illustrated in FIG. 12, the generation module 21E may generate a second software bill of materials S2 for the first software bill of materials S1A and a second software bill of materials S2 for combined software obtained by combining the first software bill of materials S1B and the first software bill of materials S1C.

The generation module 21E may generate the second software bill of materials S2 in a similar manner to the generation module 20E.

The dependency information adding module 20F, the signature adding module 20G, and the output module 20H are similar to those in the above-described embodiment.

Next, an example of a procedure of information processing executed by the information processing device 11 according to the present embodiment will be described.

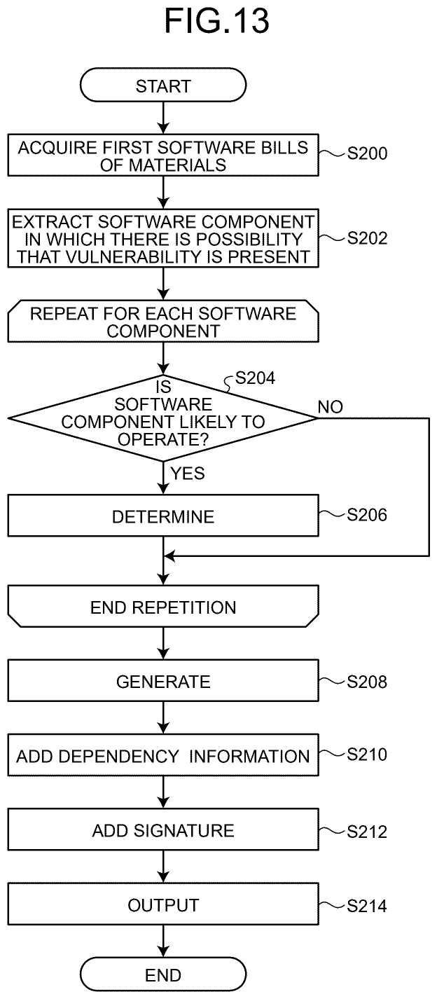

FIG. 13 is a flowchart illustrating the example of the procedure of the information processing executed by the information processing device 11 according to the present embodiment.

The acquisition module 21A acquires the plurality of first software bills of materials S1 to be processed (Step S200). Based on the vulnerability list information 12B, the extraction module 21B extracts a software component which is included in each of the plurality of first software bills of materials S1 acquired in Step S200 and has a possibility that a vulnerability is present (Step S202).

Then, the processing unit 21 repeats processing of Steps S204 and S206 for each software component extracted in Step S202.

Specifically, the operation determination module 21C determines whether or not the software component that has been extracted in Step S202 and has a possibility that a vulnerability is present is likely to operate in an introduction target device into which the software component is to be introduced (Step S204). When a negative determination is made in Step S204 (Step S204: No), the software component is determined and excluded from a target for generation of the second software bill of materials S2. When an affirmative determination is made in Step S204 (Step S204: Yes), the processing proceeds to Step S206.

In Step S206, the determination module 21D determines the software component for which the affirmative determination was made in Step S204, as a target for the generation of the second software bill of materials S2 (Step S206).

By the processing unit 21 executing the processing of Steps S204 and S206 for each software component extracted in Step S202, a plurality of software components that have been determined to be likely to operate in the introduction target device and have a possibility that a vulnerability is present among the software components included in each of the plurality of first software bills of materials S1 are determined as targets for generation of the second software bill of materials S2.

The generation module 21E generates a second software bill of materials S2 for each combined software component obtained by combining at least some of the plurality of software components determined as the targets for the generation of the second software bill of materials S2 (Step S208).

Next, the dependency information adding module 20F adds dependency information indicating a dependency between the plurality of software components included in the second software bills of materials S2 to the second software bills of materials S2 generated in Step S208 (Step S210).

The signature adding module 20G adds a signature to the second software bills of materials S2 to which the dependency information has been added (Step S212).

The output module 20H outputs the second software bills of materials S2 that have been generated in Step S208 and to which the dependency relation information and the signature have been added in Steps S210 and S212 (Step S214). Then, this routine is ended.

As described above, in the information processing device 11 according to the present embodiment, the acquisition module 21A acquires the plurality of first software bills of materials S1. The determination module 21D determines a plurality of software components having a possibility that a vulnerability is present among the software components defined in each of the plurality of first software bills of materials S1. Then, the generation module 21E generates a second software bill of materials S2 for each combined software component obtained by combining at least some of the plurality of determined software components.

For example, it is assumed that the acquisition module 21A acquires the SBOMs of the software components OS1, DriverA, and DriverC, which are integrated as the one actual software product, as the first software bills of materials S1 (the first software bills of materials S1A to SIC) (see FIG. 8). In this case, depending on a request, it may be preferable to output a second software bill of materials S2 in which at least some of these software components having a dependency are combined.

Therefore, in the information processing device 11 according to the present embodiment, the generation module 21E generates the second software bills of materials S2 for each combined software component obtained by combining at least some of the plurality of determined software components.

Therefore, in the information processing device 11 according to the present embodiment, in addition to the effects of the above-described embodiment, it is possible to manage software bills of materials of software components having vulnerability in units of software products.

Furthermore, by adding the dependency information to the second software bills of materials S2, the information processing device 11 can provide the second software bills of materials S2 hierarchized in units of software products.

Next, an example of a hardware configuration of each of the information processing device 10 and the information processing device 11 according to the above-described embodiments will be described.

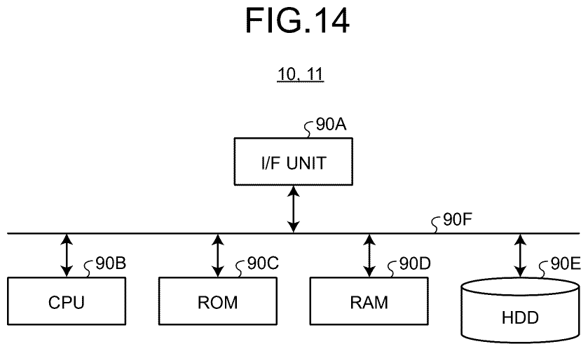

FIG. 14 is a hardware configuration diagram of an example of each of the information processing device 10 and the information processing device 11 according to the above-described embodiments.

Each of the information processing device 10 and the information processing device 11 according to the above-described embodiments includes a control device such as a central processing unit (CPU) 90B, a storage device such as a read-only memory (ROM) 90C, a random-access memory (RAM) 90D, and a hard disk drive (HDD) 90E, an I/F unit 90A that is an interface with various devices, and a bus 90F that connects the units. Each of the information processing device 10 and the information processing device 11 has a hardware configuration in which a general computer is used.

In each of the information processing device 10 and the information processing device 11 according to the above-described embodiments, the CPU 90B reads a program from the ROM 90C onto the RAM 90D and executes the program, whereby the above-described units are implemented on the computer.

Note that the program for executing the above-described processing by the information processing device 10 and the information processing device 11 according to the above-described embodiments may be stored in the HDD 90E. Furthermore, the program for executing the above-described processing by the information processing device 10 and the information processing device 11 according to the above-described embodiments may be provided by being incorporated in advance in the ROM 90C.

In addition, the program for executing the above-described processing by the information processing device 10 and the information processing device 11 according to the above-described embodiments may be stored as a file in an installable format or an executable format in a computer-readable storage medium such as a CD-ROM, a CD-R, a memory card, a digital versatile disc (DVD), or a flexible disk (FD) and provided as a computer program product. Furthermore, the program for executing the above-described processing by the information processing device 10 and the information processing device 11 according to the above-described embodiments may be stored on a computer connected to a network such as the Internet and provided by being downloaded via the network. Furthermore, the program for executing the above-described processing by the information processing device 10 and the information processing device 11 according to the above-described embodiments may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and
one or more processors coupled to the memory and configured to:
determine a software component having a possibility that a vulnerability is present, among a plurality of software components defined in a first software bill of materials; and
generate a second software bill of materials according to the determined software component.

2. The device according to claim 1, wherein
the one or more processors are configured to:
determine two or more software components having a possibility that a vulnerability is present, among the plurality of software components defined in the first software bill of materials; and
generate the second software bill of materials for each of the determined two or more software components.

3. The device according to claim 1, wherein
the one or more processors are further configured to:
extract the software component that is included in the first software bill of materials and has a possibility that a vulnerability is present, based on vulnerability list information regarding the vulnerability; and
determine the extracted software component among the plurality of software components defined in the first software bill of materials.

4. The device according to claim 1, wherein
the one or more processors are configured to:
determine two or more software components having a possibility that a vulnerability is present, among the plurality of software components defined in each of a plurality of first software bills of materials; and
generate the second software bill of materials for each of combined software components obtained by combining at least some of the determined two or more software components.

5. The device according to claim 4, wherein
the one or more processors are further configured to:
extract the software component having a possibility that a vulnerability is present, among the plurality of software components defined in each of the plurality of first software bills of materials, based on vulnerability list information regarding the vulnerability; and
determine the extracted software component among the plurality of software components defined in each of the plurality of first software bills of materials.

6. The device according to claim 3, wherein
the one or more processors are further configured to:
determine whether or not the extracted software component is likely to operate in an introduction target device into which the software component is to be introduced; and
determine the software component determined to be likely to operate among the plurality of software components defined in the first software bill of materials.

7. The device according to claim 1, wherein
the one or more processors are further configured to add, to the second software bill of materials, dependency information indicating a dependency with respect to a software component defined in another second software bill of materials.

8. The device according to claim 1, wherein
the one or more processors are further configured to add a signature to the second software bill of materials.

9. The device according to claim 8, wherein
the one or more processors are configured to add one signature to at least some or a whole of a plurality of second software bills of materials having a dependency.

10. The device according to claim 1, wherein
the one or more processors are further configured to output the second software bill of materials.

11. An information processing method executed by an information processing device, the method comprising:
determining a software component having a possibility that a vulnerability is present, among a plurality of software components defined in a first software bill of materials; and
generating a second software bill of materials according to the determined software component.

12. A computer program product comprising a computer-readable medium including programmed instructions, the instructions causing a computer to execute:
determining a software component having a possibility that a vulnerability is present, among a plurality of software components defined in a first software bill of materials; and
generating a second software bill of materials according to the determined software component.
